(19) United States
(12) Patent Application Publication
(10) Pub. No.: US 2011/0271833 A1
(43) Pub. Date: Nov. 10, 2011

(54) Adsorbent Bed Support

(75) Inventors: Stephen Clyde Tentarelli, Schnecksville, PA (US); Stephen John Gibbon, Banstead (GB)

(73) Assignee: AIR PRODUCTS AND CHEMICALS, INC., Allentown, PA (US)

(21) Appl. No.: 12/774,461

(22) Filed: May 5, 2010

(51) Int. Cl. B01D 53/04; B01D 53/047; B01D 53/26

(52) U.S. Cl. 95/104; 96/108; 95/148; 95/139; 95/121

(57) ABSTRACT

An adsorbent vessel and process for using the adsorbent vessel subject to thermal swing expansion/contraction is disclosed where the adsorbent vessel comprises a support screen affixed to the adsorption vessel subject to thermal swing expansion/contraction and where a first section of the support screen extends along a portion of the length of the adsorption vessel subject to thermal swing expansion/contraction in the axial direction and comprises apertures permitting gas permeation and where the first section of the support screen has a cross-section in the axial direction that is arcuate.

### BACKGROUND

This invention relates to treating a feed gas, and in particular, the invention relates to an apparatus, system, and process for removing, or at least reducing the level of, carbon dioxide and water in a feed gas to render it suitable for downstream processing. The invention is especially useful in removing carbon dioxide and water from air, where purified air is to be employed as a feed gas in a process for the cryogenic separation or purification of air.

In the context of cryogenic air separation, carbon dioxide is a relatively high boiling temperature gaseous material and the removal of carbon dioxide and other high boiling temperature materials, for example water, which may be present in a feed gas, is necessary where the mixture is to be subsequently treated in a low temperature process. If the relatively high boiling temperature materials are not removed, they may liquefy or solidify in a subsequent processing step and lead to pressure drops and/or flow difficulties in the downstream process. It may also be necessary or desirable to remove hazardous, for example, explosive materials, prior to further processing of the feed gas so as to reduce the risk of build-up in the subsequent process to prevent an explosion hazard. Hydrocarbon gases such as, for example, acetylene may present such a hazard, and thus, it may be desirable to remove it from the feed gas.

Water and carbon dioxide may be removed from a feed gas by adsorption using a solid adsorbent in a temperature swing adsorption (TSA), pressure swing adsorption (PSA), thermal pressure swing adsorption (TPSA), or thermally enhanced pressure swing adsorption (TEPSA) process. Generally, in these processes, water and carbon dioxide are removed from a feed gas by contacting the mixture with one or more adsorbents, which adsorb the water and carbon dioxide. The water adsorbent material may be, for example, a silica gel, an alumina, or a molecular sieve, and the carbon dioxide adsorbent material may be, for example, a molecular sieve of a zeolite.

Conventionally, water is removed first and then the carbon dioxide by passing the feed gas through a single adsorbent layer or separate layers of adsorbent selected for preferential adsorption of water and carbon dioxide in an adsorption bed or vessel. Removal of carbon dioxide and other high boiling components to a very low level is especially desirable for the efficient operation of downstream processes.

After adsorption, the flow of feed gas is shut off from the adsorbent bed and the adsorbent is exposed to a flow of regeneration gas that strips the adsorbed materials, for example, water and carbon dioxide, from the adsorbent and thereby regenerates the adsorbent for further future use.

In a TSA process for removal of water and carbon dioxide, for example, atmospheric air is typically compressed using a main air compressor (MAC) followed by indirect water-cooling and removal of the resultant condensed water in a separator as illustrated in FIG. 8 and described hereinafter. The air may be further cooled using, for example, refrigerated ethylene glycol or Direct Cooling After Cooling (DCAC). The bulk of the water is removed in this step by condensation and separation of the condensate. Gas is then passed into a molecular sieve bed or mixed alumina/molecular sieve bed system where the remaining water and carbon dioxide are removed by adsorption. By using two or more adsorbent beds in a parallel arrangement, one may be operated for adsorption while the other is being regenerated, and their roles are periodically reversed in the operating cycle. In the case of a two-bed TSA system, the adsorbent beds are operated in a TSA mode with equal periods being devoted to adsorption and to regeneration.

As a result of components (i.e., the water, carbon dioxide, etc.) being removed from a feed gas by adsorption when the bed is on-line, heat is generated due to the heat of adsorption. The heat generated by the adsorption process causes a heat pulse to move in the downstream direction through the adsorbent. In the TSA process, for example, the heat pulse is allowed to proceed out of the downstream end of the adsorbent bed during the feed or on-line period. During the regeneration process, heat must be supplied to desorb the gas component that has been adsorbed on the bed. Thus, in the regeneration step, part of the product gas, for instance nitrogen or a waste stream from a downstream process, is used to desorb the adsorbed components and may be compressed in addition to being heated. The hot gas is passed through the bed being regenerated, thus, removing the adsorbed water and/or carbon dioxide, for example. During the regeneration step, the gas may flow in the direction counter to that of the adsorption step.

In a Thermal Pressure Swing Adsorption (TPSA) system, water is typically confined to a zone in which a water adsorption medium is disposed, for example, activated alumina or silica gel. A separate layer comprising a molecular sieve for the adsorption of carbon dioxide is typically employed. In contrast with a TSA system, water does not enter the molecular sieve layer to any significant extent in a TPSA system, which advantageously avoids the need to input a large amount of energy in order to desorb the water from the molecular sieve layer. The TPSA process, as described in U.S. Pat. Nos. 5,885,650 and 5,846,295, is incorporated by reference herein in their entirety.

A Thermally Enhanced PSA (TEPSA), like TPSA, utilizes a two stage regeneration process in which the adsorbed water is desorbed by PSA and the carbon dioxide previously adsorbed is desorbed by TSA. In this process, desorption occurs by feeding a regeneration gas at a pressure lower than the feed stream and a temperature greater than the feed stream and subsequently replacing the hot regeneration gas with a cold regeneration gas. The heated regenerating gas allows the cycle time to be extended as compared to that of a PSA system, so reducing switch losses as heat generated by adsorption within the bed may be replaced in part by the heat from the hot regeneration gas. The TEPSA process, as described in U.S. Pat. No. 5,614,000, is incorporated by reference herein in its entirety.

As previously noted, TSA, TPSA, and TEPSA processes all require the input of thermal energy by means of heating the regeneration gas, but each process also has its own characteristic advantages and disadvantages. The temperatures needed for the regenerating gas in the TSA, TPSA, and TEPSA processes are typically sufficiently high, for example 50° C. to 200° C., as to place significant demands on the system engineering, that, therefore, increases costs. Typically, there will be more than one unwanted gas component, which is removed in the process, and generally one or more of these components will adsorb strongly, for example, the water component, and another much more weakly, for example, the carbon dioxide component. The high temperature used for regenerating needs to be sufficiently high for the desorption of the more strongly adsorbed component.

The high temperatures employed in the TSA, TPSA, and TEPSA processes require particular or specially designed adsorber vessels with high mechanical integrity to achieve optimum trace removals from the feed gas, and in this case, air.

The article, Designs of Adsorptive Dryers in Air Separation Plants, by Dr. Ulrich von Gemmingen, in the Linde Reports on Science & Technology 54/1994, pp. 8-12, discloses process schemes and the design of adsorptive dryers for air separation plants. A comprehensive overview of the different types of adsorber vessels and screen arrangements was reported, including vertical, radial, and horizontal geometry adsorbers and support screen systems.

These adsorber vessel geometries all have a common feature; the adsorbent must be supported by a “screen internal” or support screen that is a perforated material which supports the weight of the adsorbent, its own, weight, and any forces resulting from a pressure drop across the support screen and is designed to work with adequate elasticity under thermal cyclic conditions. Traditional support screens are normally supported by the vessel wall along with use of a support system and must withstand cyclic operation without failure. Traditional adsorbent bed support systems in horizontal vessels comprise some sort of flat bed support screen that is then supported on an array of support beams or “legs,” or an array of tubular type distributor screens where the screens are typically made of V-wire or a perforated plate covered with mesh.

U.S. Pat. No. 6,086,659, to Tentarelli, discloses a radial flow adsorption vessel together with a method for assembling such a vessel and a method for manufacturing containment screens having unidirectional flexibility and bidirectional flexibility for use in such a vessel, which is hereby incorporated by reference in its entirety.

The common problem with all these adsorbent bed support systems is that as a consequence of the varying temperatures, including the temperature pulse moving through the adsorbent bed, there are times in the cycle that the adsorbent in the adsorbent bed, the adsorbent bed support system, and the adsorbent vessel are all at different temperatures. As a result of this difference in temperature, there is differential thermal expansion between the adsorbent bed support system and the adsorbent vessel wall, thus requiring the adsorbent bed support system to be able to move/slide relative to the adsorbent vessel.

This requirement for the adsorbent bed support system to have the ability to move/slide relative to the adsorbent vessel makes the design that permits welding the two items together difficult to achieve and generally necessitates some sort of mechanical seal between the adsorbent bed support system and the adsorbent vessel because the primary function of the adsorbent bed support system is to contain the adsorbent. Hence, the adsorbent bed support system “seal” has to accommodate the differential thermal expansion between the adsorbent bed support system and the adsorbent vessel wall without permitting any adsorbent (often with particle sizes as little as 1.5 mm to 0.5 mm) to leak past the adsorbent bed support system seal.

The amount of differential expansion that needs to be accommodated depends on the physical size of the support screen, the temperature difference between the support screen (which is part of the adsorbent bed support system) and the adsorbent vessel, and the relative coefficients of thermal expansion. The adsorbent bed support system seal must accommodate such differential thermal expansion.

Any adsorbent leakage may be disastrous to the normal operation of the adsorbent vessel, particularly one with multiple adsorbent beds and very costly to repair. If adsorbent leakage occurs, locally the level of the adsorbent closest to the support screen will drop and will be back filled with the adsorbent further away from the support screen resulting in an uneven adsorbent bed surface. This uneven adsorbent bed surface will lead to the backfilled part of the lower bed to perform improperly due to flow distribution and pressure drop issues and adsorber bed malperformance. Even with a single bed, the bed depth will be reduced locally above the leak, causing premature breakthrough of containments. The cost to repair a medium-sized Air Separation Unit adsorbent bed due to leakage may exceed $1,000,000, which does not include the loss of production costs associated with such repair.

Traditional adsorbent bed support systems have to support the mass of the adsorbent required for the separation duty. The frictional loads on their supports can be large from resisting the differential movement as a result of the potential temperature differences and will generate large forces in the adsorbent bed support system. These large forces often result in mechanical failures of typical support screens. Furthermore, because the adsorbent beads sizes can be relatively small (i.e., as little as 1.5 mm to 0.5 mm, for example), relatively tight mechanical tolerances are required making the adsorbent bed support system difficult and expensive to fabricate.

Further, traditional adsorbent bed support systems generally incorporate some sort of packed joint, typically containing glass fiber rope or wire wool packing materials. These systems/materials all tend to degrade over time, and eventually, the integrity of the seal will be compromised leading to adsorbent leaking past the adsorbent bed support system seals, failure of the adsorbent system, and high repair costs.

Designing a new reliable adsorbent bed support system has, however, plagued the industry for many years, and in fact, there has been a persistent long-felt, but unresolved need in the industry to improve the mechanical integrity of the adsorbent bed support system under cyclic temperature swing adsorption conditions and to alleviate thermal stresses near the seal point where most of the failures occur. Ideally the adsorbent bed support system should be strong and structurally efficient to support the bed weight, the forces associated with pressure drop across the support screen, flexible enough to accommodate thermal expansion, provide low pressure drop, make efficient use of the adsorbent vessel volume, reliably contain small particles or adsorbent, and allow for uniform distribution of flow through the adsorbent bed.

### Example 1

As an example, a horizontal geometry adsorbent vessel TSA system is designed to remove water and carbon dioxide at a feed pressure of approximately 5.5 bara, and a regeneration pressure of approximately 1.1 bara. The air and regeneration flow rates are 415,000 Nm³/hr and 49,400 Nm³/hr respectively. The cycle time for the TSA (feed and regeneration) system is approximately 8 hours. The support screen is, therefore, expected to experience a temperature differential of 120° C. as between the support screen and the adsorbent vessel every 8 hours for a duration of 2 hours where the air feed temperature was at 9.1° C., while supporting, across a 81 m² area, 120,000 kg of adsorbent.

### BRIEF SUMMARY

The described embodiments satisfy the need in the art by providing, in one embodiment, an adsorbent vessel subject to thermal swing expansion/contraction, comprising a support screen affixed to the adsorption vessel subject to thermal swing expansion/contraction, wherein a first section of the support screen extends along a portion of the length of the adsorption vessel subject to thermal swing expansion/contraction in the axial direction and comprises apertures permitting gas permeation, and wherein the first section of the support screen has a cross-section in the axial direction that is arcuate.

In another embodiment, a process for separation of a gaseous mixture carried out by the adsorbent vessel subject to thermal swing expansion/contraction is disclosed where the adsorbent vessel is subject to thermal swing expansion/contraction, and comprises a support screen affixed to the adsorption vessel subject to thermal swing expansion/contraction, wherein a first section of the support screen extends along a portion of the length of the adsorption vessel subject to thermal swing expansion/contraction in the axial direction and comprises apertures permitting gas permeation, and wherein the first section of the support screen has a cross-section in the axial direction that is arcuate.

In yet another embodiment, a process for separation of a gaseous mixture is disclosed, comprising introducing a feed stream to be purified into an adsorbent vessel subject to thermal swing expansion/contraction, wherein the adsorbent vessel comprises a support screen affixed to an inside wall of the adsorption vessel where at least a first section of the support screen has a cross-section in the axial direction that is arcuate such that the feed stream to be purified in the adsorbent vessel passes through the support screen and is in contact with at least a first adsorbent; and adsorbing at least one component out of the feed stream resulting in a purified feed stream.

### BRIEF DESCRIPTION OF SEVERAL VIEWS OF THE DRAWINGS

The foregoing summary, as well as the following detailed description of exemplary embodiments, is better understood when read in conjunction with the appended drawings. For the purpose of illustrating embodiments, there is shown in the drawings exemplary constructions; however, the invention is not limited to the specific methods and instrumentalities disclosed. In the drawings:

FIG. 1 is a cross-sectional view of an adsorbent vessel comprising an exemplary adsorbent bed support system including a support screen, in accordance with the present invention;

FIG. 2 is a cut-away view of FIG. 1 of an exemplary adsorbent bed support system, in accordance with the present invention;

FIG. 3 is a cross-sectional view in perspective of two support screen plates welded together to form the support screen, in accordance with the present invention;

FIG. 4A is a cross-sectional view of an adsorbent vessel comprising an exemplary support screen with a slight designed deviation, in accordance with the present invention;

FIG. 4B is a cross-sectional view of an adsorbent vessel comprising an exemplary support screen with a greater designed deviation based on thermal expansion, in accordance with the present invention;

FIG. 5A is a sectional view in perspective of an absorbent vessel comprising an exemplary support screen and illustrating an exemplary transition section, in accordance with the present invention;

FIG. 5B is a sectional view in perspective of an absorbent vessel comprising an exemplary support screen and illustrating an exemplary transition section, in accordance with the present invention;

FIG. 5C is a sectional view in perspective of an absorbent vessel comprising an exemplary support screen and illustrating an exemplary transition section, in accordance with the present invention;

FIG. 5D is a sectional view in perspective of an absorbent vessel comprising an exemplary support screen and illustrating an exemplary transition section, in accordance with the present invention;

FIG. 6 is a perspective view with a partial sectional view of an absorbent vessel comprising an exemplary support screen, in accordance with the present invention;

FIG. 7A is a sectional view in perspective of an absorbent vessel comprising an exemplary support screen and illustrating an exemplary transition section, in accordance with the present invention;

FIG. 7B is a partial cross-sectional view of an absorbent vessel comprising an exemplary support screen and illustrating an exemplary transition section, in accordance with the present invention; and

FIG. 8 is a flow diagram of adsorbent vessel comprising an exemplary support screen being used in an adsorbent system, in accordance with the present invention.

### DETAILED DESCRIPTION OF THE INVENTION

The foregoing summary, as well as the following detailed description of exemplary embodiments, is better understood when read in conjunction with the appended drawings. For the purpose of illustrating embodiments, there is shown in the drawings exemplary constructions; however, the invention is not limited to the specific methods and instrumentalities disclosed.

An adsorbent bed support system that is flexible to accommodate differential thermal expansion, having axial flexibility provided by a perforation pattern comprising of staggered apertures or slots in the support screen and transverse flexibility provided by the ability of the support screen to change its curvature is disclosed. The relatively thin support screen has significant strength and structurally integrity and uses membrane tension to support its weight and the weight of the adsorbent material. The disclosed adsorbent bed support system does not require structural beams for support and is easily attached to the adsorbent vessel or shell by welding or bolting. Because no structural beams are present, there is no obstruction of the gaseous flow by the structural beams resulting in smooth flow patterns in the void space between the inlet of the gaseous flow and the support screen. The smooth flow patterns result in low pressure drop across the bed and allow for relatively thin beds with large cross-sectional flow. The apertures incorporated in the support screen, where the apertures may be slots, for example, may be open or may also be covered with a mesh if particles are small enough to fall through the apertures.

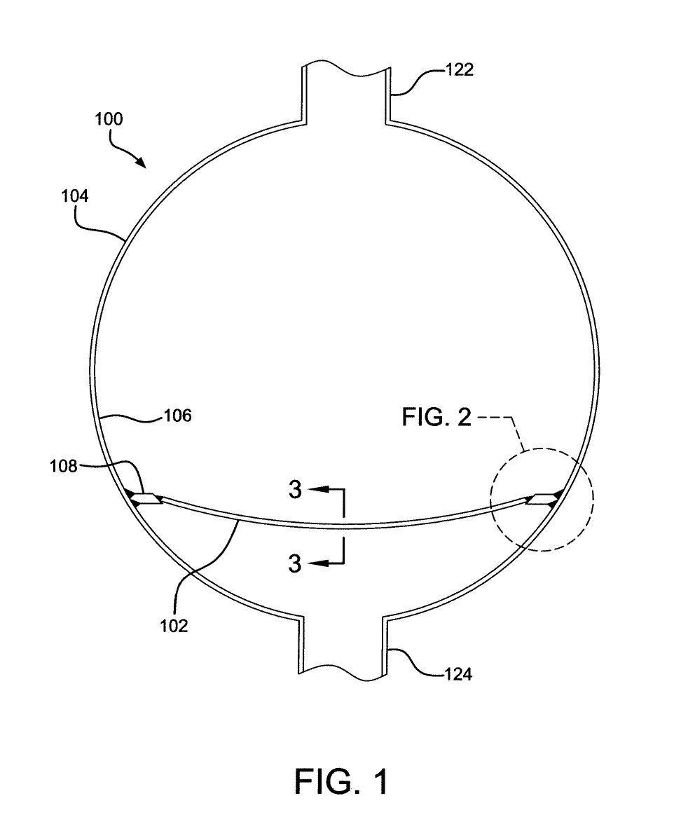

FIG. 1 illustrates exemplary adsorbent bed support system 100 where a support or hammock screen 102 is incorporated in an adsorbent vessel 104 in accordance with the present invention. The support screen 102 is affixed to the inside vessel wall 106 of the adsorbent vessel 104 through the use of a ledge 108. The ledge 108 may be 25 mm thick and 75 mm deep, for example. As illustrated in FIG. 1, the support screen 102 has a cross section in the axial direction that forms an arcuate or curve from one side of the inside vessel wall 106 to the other side of the inside vessel wall 106. As used in this description and in the appended claims, the word “arcuate” means having a form of a bow or a curve, including catenary curves or other curved forms. The support screen 102 is concave up, as illustrated in FIG. 1. As illustrated in FIG. 1, the adsorbent vessel 104 comprises two openings 122, 124 for the introduction and removal of both feed streams and regeneration streams, depending on whether the bed is operating (i.e., performing adsorption) or regenerating. The adsorbent vessel 104 may comprises more than two openings, for example.

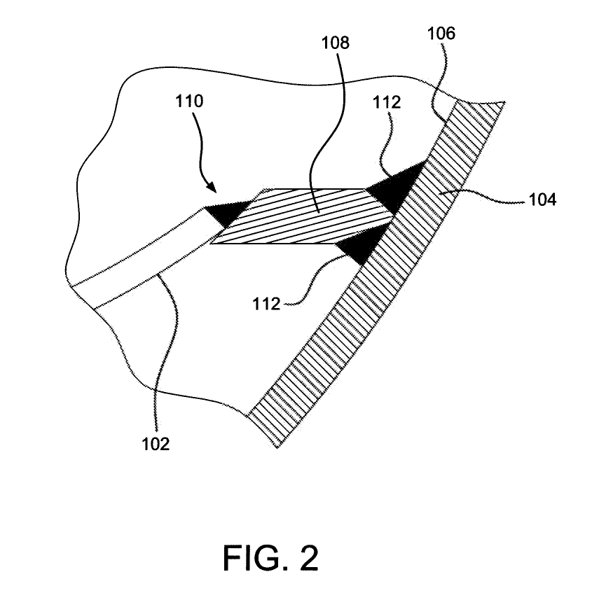

As illustrated in FIG. 2, the support screen 102 may be welded to the ledge 108 using a fillet weld 110. The ledge 108 is welded to the inside wall 106 of the adsorbent vessel 104 using full penetration welds 112. The support screen 102 may also be fully welded to the inside vessel wall 106 without the use of a ledge 108. Other types of welds or traditional methods for affixing the support screen 102 to the ledge 108 or the wall 106 or the ledge 108 to the inside wall 106 may also be used, including bolting.

The support screen 102 design, including its shape and slotted pattern allow it to be flexible to accommodate differential thermal expansion between the support screen 102 and the adsorbent vessel 104 in the axial and transverse directions. The axial direction, as described herein, shall mean, relate to, or be characterized by or forming an axis along the length of the adsorbent vessel 104 from one head 120 of the adsorbent vessel 104 to the opposing head 120 of the adsorbent vessel 104. The transverse direction, as described herein, shall mean a direction perpendicular to the axial direction. The staggered slotted pattern provides axial flexibility while its transverse flexibility stems from the support screen's 102 ability to change its curvature. The ample open area created by the slots or openings 116 permits slight pressure drop across the support screen 102. The slots 116 can also be covered with a mesh if the particles or adsorbent are small enough to fall through.

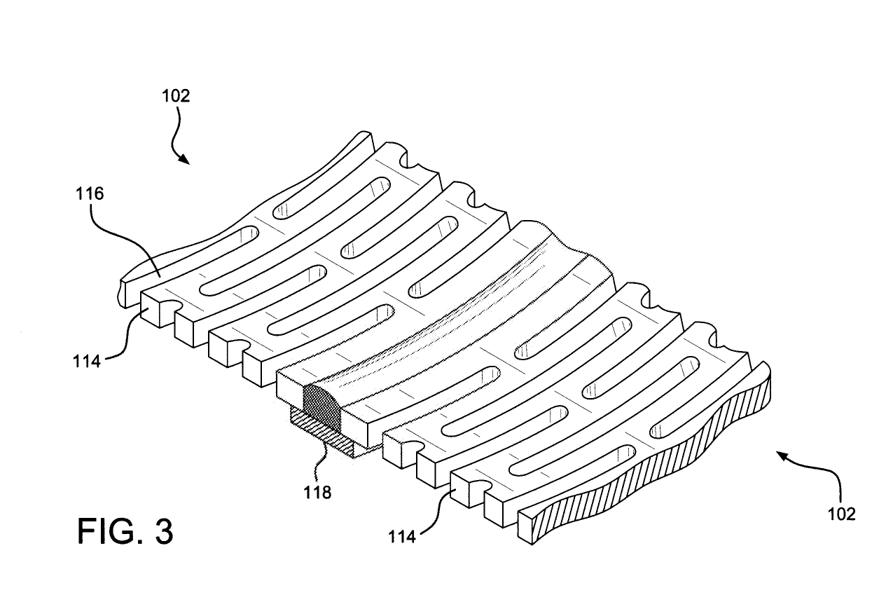

The support screen 102 may comprise a single or a plurality of slotted plates 114 comprising the slots 116, as illustrated in FIG. 3. The slotted plates 114 may be 3 meters to 5 meters in length in the axial direction, for example. The slotted plates 114 may be 1.5 meters to 4 meters, in length in the transverse direction, for example. The slotted plates 114 are welded together in conjunction with a backing strip 118, for example. They may also be butt welded together without a backing strip 118. The slotted plates 114 may also be stitch welded or bolted, for example.

The support screen 102 eliminates the need for any sliding seal system, packing of joints, or design of tight fabrication tolerances. While the support screen 102 is still subject to the same differential expansion issues as a traditional adsorbent bed support system, the exemplary support screen 102 dramatically reduces or even eliminates the large frictional forces generated in the traditional systems because the support screen 102 does not slide on any supports. In a typical TSA design as described in Example 1, the support screen will experience varying temperatures and pressures throughout its cyclic operation. During the feed step, the support screen will experience a pressure of 5.5 bara and a fixed temperature of approximately 9° C.

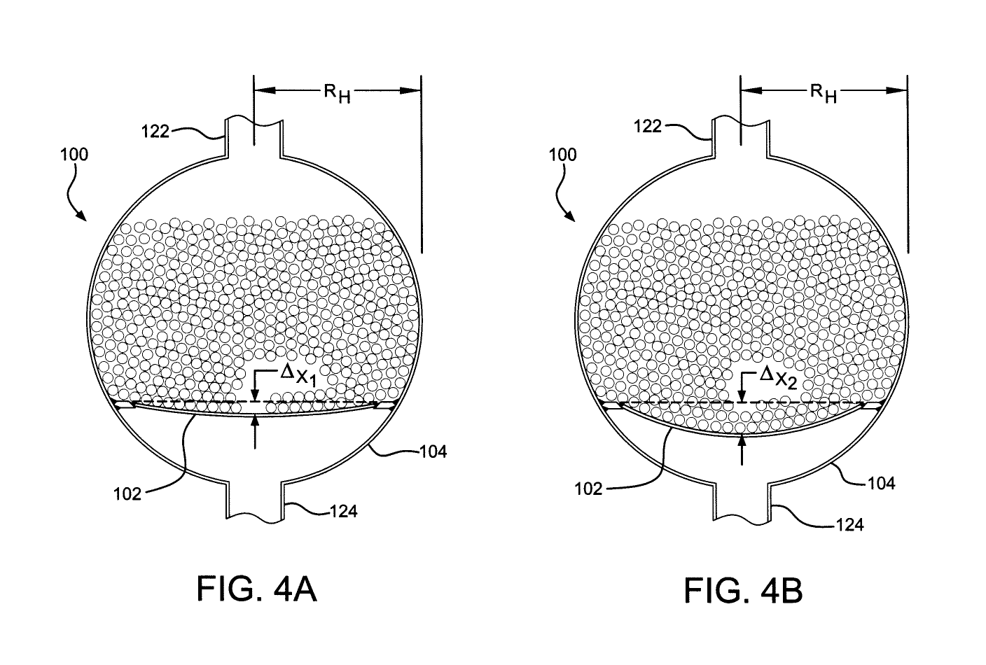

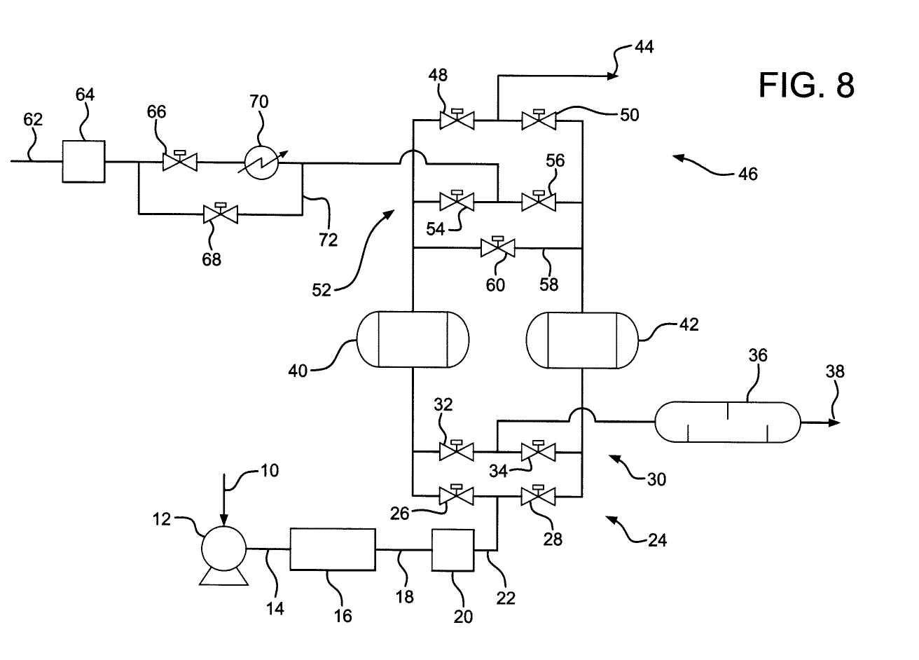

FIG. 4A shows that the support screen 102 a moderate designed deviation ΔX₁ during the feed step. During the purge step, the pressure is reduced and the support screen 102 is subject to much higher temperatures while the adsorbent vessel may only experience slightly higher temperatures. Most of the heat generated by heater 46, as illustrated in FIG. 8, during the purge step is consumed by the adsorber bed; however, some residual heat will exit the adsorber bed during the purge step and will inevitably heat up the support screen. This dramatic increase in temperature will force the support screen to expand. The curved nature of the proposed support screen will naturally allow the support screen to expand and deflect downward to a position from ΔX₁ to ΔX₂ as illustrated in FIG. 4B. As illustrated in FIG. 4A and FIG. 4B, ΔX₂ will be greater than ΔX₁. It should be appreciated that while FIG. 4A and FIG. 4B show large deflections between ΔX₁ and ΔX₂, the deflections in reality, may be very small and not recognizable to the human eye. The examples shown in FIG. 4A and FIG. 4B, and specifically the deflections ΔX₁ and ΔX₂, are provided for exemplary purposes only.

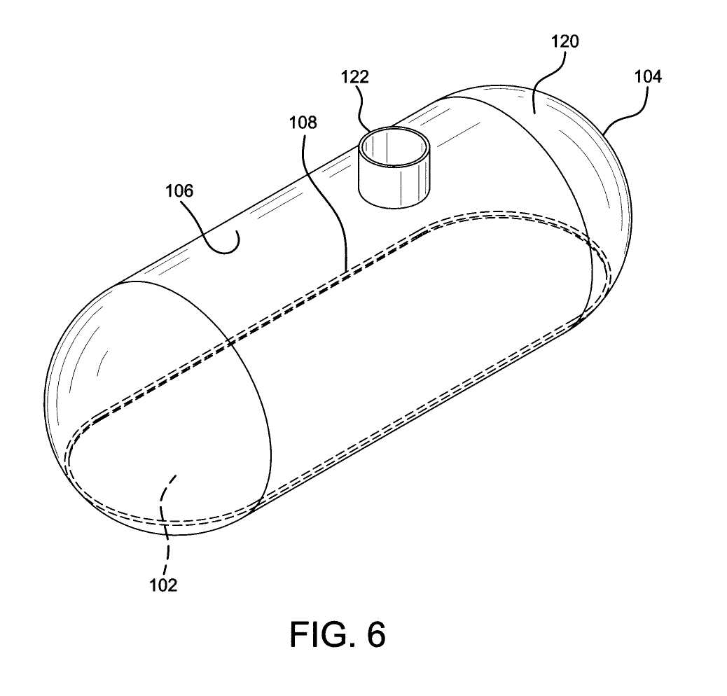

For example, the exemplary support screen 102 is affixed to the ledge 108 that runs along the periphery of the inside vessel wall 106 as illustrated in FIG. 6. The support screen 102 is under tension once adsorbent material is placed upon the support screen 102. When the support screen experiences thermal contraction, for example, due to decreased temperatures, the slots 116, illustrated in FIG. 3, will “open up” in the axial direction, and the support screen 102 will contract in transverse direction causing the support screen 102 to move more towards the position illustrated in FIG. 4A. When the support screen experiences thermal expansion, for example, due to increased temperatures, the slots 116, illustrated in FIG. 3, will “close up” in the axial direction and the support screen 102 will expand in transverse direction causing the support screen 102 to move from the position in FIG. 4A to the position illustrated in FIG. 4B.

In the transverse direction, the differential expansion of the support screen 102 relative to the adsorbent vessel 104 is accommodated by relatively small changes in the support radius R_{H}. Clearly to minimize the differential expansion effects, it is desirable to select a screen material that has a coefficient of linear expansion similar to that of the adsorbent vessel 104, however, this is not necessary or even essential. Typically TSA vessels are comprised of carbon steel, therefore, it is better that the support screen 102 is made of a ferritic alloy, for example, so as to have a comparable coefficient of expansion.

Regarding the coefficient of thermal expansion (cte), ferritic steels or alloys with a coefficient of thermal expansion that is similar to or matches the coefficient of thermal expansion of carbon steel is preferred over an austenitic steel. Ideally, the coefficient of thermal expansion of the support screen 102 would be a bit less than that of the adsorbent vessel 104 because the temperature swing of the support screen 102 will almost certainly be higher than that of the adsorbent vessel because there is better heat transfer between the gas and the support screen than between the gas and the shell.

The support screen 102 may be made of plate metal that has been cut with a special pattern of slots or openings 116. The pattern may be a slotted pattern, for example and as illustrated in FIG. 3, or a pattern that provides a low stiffness in the adsorbent vessel's axial direction, while maintaining a near normal stiffness in the transverse direction.

As the conditions in the bottom of an adsorbent vessel can be quite corrosive to plain carbon steels, a corrosion-resisting ferritic stainless steel, for example, may be useful for the proposed support screen 102.

The support screen 102 carries the weight of the adsorbent bed in membrane tension in the transverse direction. As a result of this, the support screen 102 can be relatively thin. For example, the support screen may be only 6 mm to 10 mm thick, whereas a comparable traditional flat screen may be required to be 19 mm to 25 mm thick and also require an extensive array of structural supports, including I-beams or prop-type supports below it. The support screen 102, consequently, has less mass, will require less energy to heat and cool, and has no required support structure below it to interfere with the gas flow. Also, because no support structure is necessary, the support screen 102 may also be mounted lower in the adsorbent vessel 104 allowing more space for adsorbent material. Hence, smaller vessels, for a given process duty, may be used because of the additional adsorbent material allowed. The support screen 102 may also be subject to less of a pressure drop and provide for better axial distribution of gas in the adsorbent vessel 104 as a result of its structure compared with traditional screens.

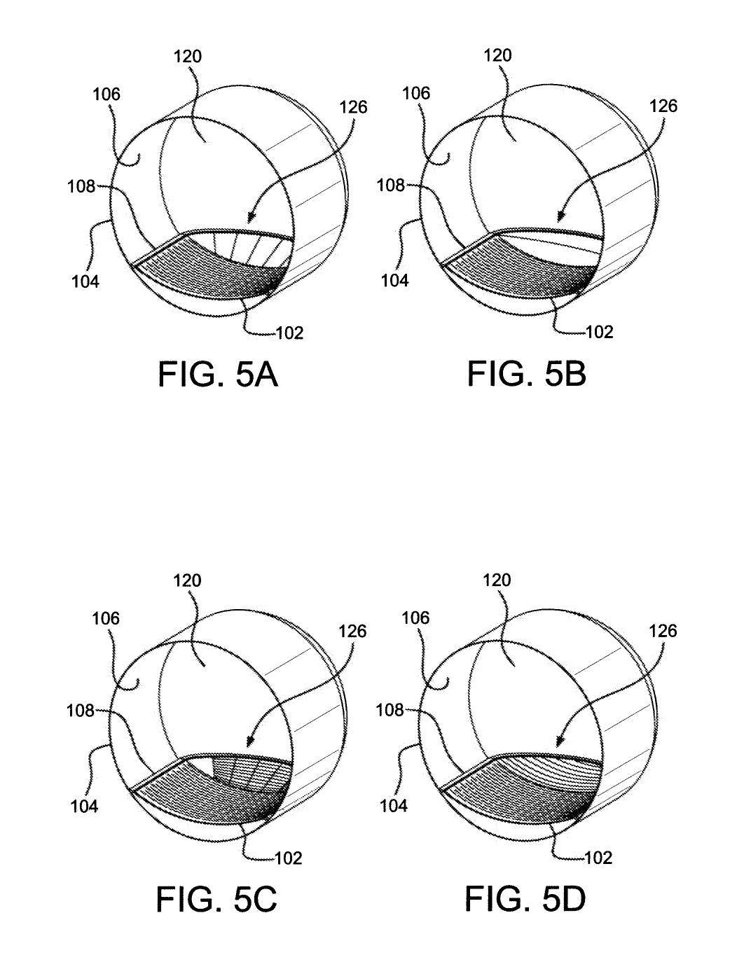

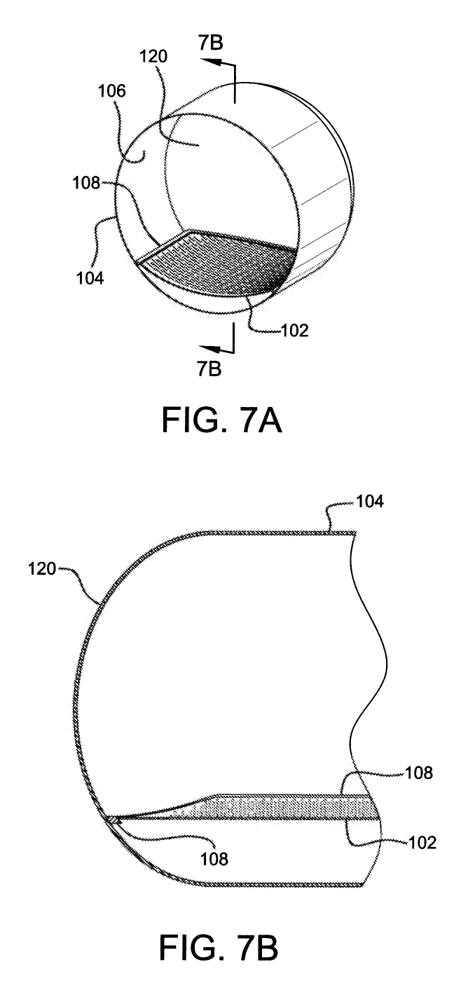

As with all horizontal vessel bed support screens, the head 120 of the adsorbent vessel 104 is specially designed as illustrated in FIGS. 5A-5D, 6, and 7A-7B. The connection of the support screen 102 to the vessel heads 120 can be achieved in a number of ways. First, the support screen 102 may simply be projected into the head 120 and cut to suit the dished head profile and then welded directly to the inside surface of the head 120 as illustrated in FIGS. 7A and 7B. Second, the connection of the support screen 102 to the head 120 can be made via a continuation of the ledge 108 and a transition section 126 as illustrated in FIGS. 5A-5D. The transition section 126 matches the profile of the support screen 102 on one edge and that of the ledge 108 in the dished head 120 on its other edge.

One form of this transition section 126, illustrated in FIG. 5D, may use a small section of a larger dished end. In fact, the section required to provide the transition between the vessel dished end and the support screen 102 would only have to be a small section of the knuckle from the larger dished end. Assuming that the larger dished end was of a crown and segment type end, only the knuckle segments would be required.

Another form of transition section 126 may use 3 conical sections, illustrated in FIG. 5C. A modification to this exemplary embodiment is for the transition section 126 to comprise one conical section and two flat sections (not shown). A further exemplary transition section 126 could comprise five essentially ‘flat’ panels where the panels would be curved on one edge to suit the support radius as illustrated in FIG. 5A. Another embodiment of the transition section 126 may comprises a vertical panel and a horizontal panel illustrated in FIG. 5B. The vessel transition section 126 may be made of a perforated material, for example, or it may not be perforated.

The support screen 102 may be used in all horizontal vessels, including adsorbent vessels with a diameter of 3 meters to 6 meters, for example. The support screen technology may be applied to any adsorption system regardless of the pressures, temperatures, adsorbents, or adsorbates used.

The support screen 102 may provide more uniform flow path lengths than a conventional horizontal TSA bed support configuration and more efficient adsorbent bed utilization and operation as there are no support beams to obstruct the flow.

Table 1 lists the process boundaries for an air separation system TSA design.

TABLE 1

| | Units | Preferred Range | Most preferred range |
|---|---|---|---|
| Feed pressure | bara | 3 to 40 | 5 to 15 |
| Air Feed Temp | ° C. | 5 to 60 | 10 to 30 |
| Purge Inlet | ° C. | 5 to 50 | 10 to 30 |
| temperature | | | |
| Feed CO₂ | ppm | 100 to 2000 | 300 to 600 |
| Purge | bara | 0.3 to 20 | 1.05 to 3 |
| pressure | | | |

The support screen 102 may be employed in the adsorbent system illustrated in FIG. 8. As illustrated in FIG. 8, an air feed 10 to be purified is fed to a main air compressor (MAC) 12 where the air feed may be compressed in multiple stages. Intercoolers and aftercoolers (not shown) may also be employed in conjunction with the main air compressor 12. A cooler 16 may be fluidly connected to the main air compressor 12 to condense at least some of the water vapor from the cooled compressed air 14. A separator 20 is then fluidly connected to the cooler 16 to remove water droplets from the compressed cooled air 18.

The separator 20 is connected to an inlet manifold 24, containing inlet control valves 26 and 28 to which is connected a pair of adsorbent bed containing vessels 40 and 42. The inlet manifold 24 is bridged downstream of the control valves 26 and 28 by a venting manifold 30 containing venting valves 32 and 34, which serve to close and open connections between the upstream end of respective adsorbent vessels 40 and 42 and a vent 38 via a silencer 36. Each of the two adsorbent vessels, 40 and 42, contains an adsorbent bed preferably containing two adsorbents (not shown). The upstream portion of the adsorbent beds contains an adsorbent for removing water, for example, activated alumina or modified alumina, and the downstream portion of the adsorption beds, contains adsorbent for the removal of carbon dioxide, for example, zeolite, for removing CO₂, N₂O, and residual water and hydrocarbons.

The apparatus has an outlet 44 connected to the downstream ends of the two adsorbent vessels, 40 and 42, by an outlet manifold 46 containing outlet control valves 48 and 50. Outlet 44 is suitably connected to a downstream processing apparatus, for example, a cryogenic air separator (not shown). The outlet manifold 46 is bridged by a regenerating gas manifold 52 containing regenerating gas control valves 54 and 56. Upstream from the regenerating gas manifold 52, a line 58 containing a control valve 60 also bridges across the outlet manifold 46.

An inlet for regenerating gas is provided at 62 which, through control valves 66 and 68 is connected to pass either through a heater 70 or via a by-pass line 72 to the regenerating gas heater 64. The regeneration gas suitably is obtained from the downstream processing apparatus fed by outlet 44.

In operation, the air feed 10 to be purified is fed to a main air compressor 12 where it is compressed, for example, in multiple stages. The air feed 10 may be further cooled through the use of intercoolers and aftercoolers (not shown) that heat exchange with water, for example. The compressed air feed 14, optionally, may then be sub-cooled in cooler 16 so as to condense at least some of the water vapor from the cooled compressed air. The compressed cooled air 18 is then fed to a separator 20 that removes water droplets from the compressed cooled air 18. The dry air feed 22 is then fed to the inlet manifold 24 where it passes through one of the two adsorbent vessels 40, 42 containing adsorbent. Starting from a position in which air is passing through open valve 26 to adsorbent vessel 40, and through open valve 48 to the outlet 44, valve 28 in the inlet manifold will just have been closed to cut-off vessel 42 from the dry air feed 22 for purification. At this stage, valves 50, 56, 60, 32, and 34 are all closed. The adsorbent bed 40 is on-line and bed 42 is to be regenerated.

To regenerate bed 42, the bed is first depressurized by opening valve 34. Once the pressure in the vessel 42 has fallen to a desired level, valve 34 is kept open whilst valve 56 is opened to commence a flow of regenerating gas. The regenerating gas will typically be a flow of nitrogen that is dry and free of carbon dioxide obtained from the air separation unit cold box (not shown), possibly containing small amounts of argon, oxygen and other gases, to which the air purified in the apparatus shown is passed. Valve 68 is closed and valve 66 is opened so that the regenerating gas is heated to a temperature of, for example, 100° C. before passing into the vessel 42. Although the regenerating gas enters the vessel 42 at the selected elevated temperature, it is very slightly cooled by giving up heat to desorb carbon dioxide from the upper, downstream portion of the adsorbent in the vessel. Since the heat pulse is consumed in the system, the exit purge gas emerges from the vent outlet 38 in a cooler state.

The molecular sieve zeolite may be any one of those known for this purpose in the art, for example, CaX, CaLSX, NaX, NaLSX, NaY, 3A, 4A, and 5A. One may employ a single adsorbent of the kind described in, for example, U.S. Pat. No. 5,779,767, to Golden et al. (i.e., an absorbent comprising a mixture of zeolite and alumina).

While the apparatus, system, and process disclosed herein focuses on use in vessel internals that are preferably used in Horizontal TSA (HTSA) systems, nothing contained herein limits the apparatus, systems, and processes to such use.

### Example 2

An exemplary support screen incorporated into an adsorbent vessel having a vessel diameter of 168 inches (4.2672 meters) has a nominal screen radius of 170.7 inches (4.3358 meters). The nominal distance between the bottom of the adsorbent vessel and the bottom of the screen is 23.28 inches (0.5913 meters). The support screen thickness is 0.375 inches (9.525 millimeters). The temperature swing of the support screen is 111.1° C. (where Tₘₐₓ−Tₘᵢₙ=111.1° C.). The calculated movement (up and down relative to gravity) of the support screen is 0.33 inches (+/−0.165 inches) (8.382 millimeters (+/−4.191 millimeters) where it is assumed that the support bed moves up and down freely. The movement of the support screen is roughly linear with the temperature swing. The up and down movement due to a reversal in the direction of flow through the adsorbent bed and the resulting change in the loading on the support screen is estimated to be less than 4% of the movement caused by a 111.1° C. temperature swing (assumed dP=+/−1.5 psi (0.1034 bar) across the adsorbent bed). The total downward displacement of the support screen due to the weight of an 84 inch (2.1336 meter) deep adsorbent bed is again estimated to be less than 4% of the movement caused by a 111.1° C. temperature swing. The movements of the support screen due to a reversal in flow direction and the downward movement due to the weight of the bed are insignificant when compared to the movements that are caused by differential thermal expansion. The range of up and down movement of the support screen will be less than 0.5% of the vessel diameter, and more typically only about 0.2% of the vessel diameter.

While aspects of the present invention have been described in connection with the preferred embodiments of the various figures, it is to be understood that other similar embodiments may be used or modifications and additions may be made to the described embodiment for performing the same function of the present invention without deviating therefrom. Therefore, the claimed invention should not be limited to any single embodiment, but rather should be construed in breadth and scope in accordance with the appended claims.

1. An adsorbent vessel subject to thermal swing expansion/contraction, comprising:
a support screen affixed to the adsorption vessel subject to thermal swing expansion/contraction, wherein a first section of the support screen extends along a portion of the length of the adsorption vessel subject to thermal swing expansion/contraction in the axial direction and comprises apertures permitting gas permeation, and wherein the first section of the support screen has a cross-section in the axial direction that is arcuate.

2. The adsorbent vessel of claim 1, further comprising a ledge positioned along the periphery of the inside surface of the adsorption vessel subject to thermal swing expansion/contraction and affixed thereto such that the ledge is positioned between a first opening and a second opening of the adsorbent vessel, wherein the support screen is affixed to the ledge.

3. The adsorbent vessel of claim 1, wherein the support screen is composed of a corrosion-resistant ferritic steel.

4. The adsorbent vessel of claim 1, wherein the apertures are slots.

5. The adsorbent vessel of claim 1, wherein the support screen further comprises a transition section affixed to the first section of the support screen and the adsorption vessel forming a pocket in a head portion of the adsorbent vessel.

6. The adsorbent vessel of claim 5, wherein the transition section comprises apertures permitting gas permeation.

7. A process for separation of a gaseous mixture carried out by the adsorbent vessel subject to thermal swing expansion/contraction of claim 1.

8. The process of claim 7, wherein the gaseous mixture is air.

9. The process of claim 8, wherein a feed pressure of the air is between 3 to 40 bara.

10. The process of claim 8, wherein a purge pressure of a regeneration gas is between 0.3 to 20 bara.

11. The process of claim 8, wherein the air feed temperature is between 5 to 60° C.

12. The process of claim 7, wherein the adsorbent vessel subject to thermal swing expansion/contraction comprises an adsorbent zeolite selected from the group consisting of: CaX, CaLSX, NaX, NaLSX, NaY, 3A, 4A, and 5A.

13. The process of claim 7, wherein the adsorbent vessel subject to thermal swing expansion/contraction comprises a desiccant of silica gel or activated alumina.

14. A process for separation of a gaseous mixture, comprising:
introducing a feed stream to be purified into an adsorbent vessel subject to thermal swing expansion/contraction, wherein the adsorbent vessel comprises a support screen affixed to an inside wall of the adsorption vessel where at least a first section of the support screen has a cross-section in the axial direction that is arcuate such that the feed stream to be purified in the adsorbent vessel passes through the support screen and is in contact with at least a first adsorbent; and
adsorbing at least one component out of the feed stream resulting in a purified feed stream.

15. The process of claim 14, wherein the feed stream is air.

16. The process of claim 15, wherein the feed pressure of the air is between 3 to 40 bara.

17. The process of claim 14, further comprising regenerating the adsorbent vessel, wherein the purge pressure of a regeneration gas to be used to regenerate the adsorbent vessel is between 0.3 to 20 bara.

18. The process of claim 15, wherein the temperature of the air is between 5 to 60° C.

19. The process of claim 14, wherein the adsorbent vessel subject to thermal swing expansion/contraction comprises an adsorbent zeolite selected from the group consisting of: CaX, CaLSX, NaX, NaLSX, NaY, 3A, 4A, and 5A.

20. The process of claim 14, wherein the adsorbent vessel subject to thermal swing expansion/contraction comprises a desiccant of silica gel or activated alumina.
